(19) United States
(12) Patent Application Publication
(10) Pub. No.: US 2025/0021377 A1
(43) Pub. Date: Jan. 16, 2025

(54) WORKFLOW ENGINE

(71) Applicant: DISCORD INC., San Francisco, CA (US)

(72) Inventors: Alec Gorge, San Jose, CA (US); Jacob Richards, Los Angeles, CA (US)

(21) Appl. No.: 18/349,638

(22) Filed: Jul. 10, 2023

(51) Int. Cl. G06F 9/48

(52) U.S. Cl. CPC G06F 9/4881

(57) ABSTRACT

The present technology provides a workflow management system that creates workflows of sequential workflow tasks with various dependencies and an input of a particular dataset of objects that needs to be operated on or analyzed to result in an intended output. The customization can include a number and order of sequential workflow steps as well as a number and function of workflow tasks to be executed in parallel at each of the workflow steps. When the workflow tasks are ready to be run, they may be queued up with an asynchronous task message server that services a server that supports near real-time communications. The asynchronous task service may be a message-oriented middleware that provides a queue to parallelize workflow tasks.

### BACKGROUND

Some social networks are developed around friendships, professional relationships, or other individual connections, and some social networks create communities around topics. Often social networking platforms provide services through which users can form or interact within a social network. While social networks can provide entertainment, networking, commercial, or informational value, they are also subject to various challenges. Social networking platforms, like other technology platforms, may need to run various kinds of workflow tasks, ranging from billing workflow tasks to operational workflow tasks. The different kinds of workflow tasks may vary in the number of workflow steps required as well as the volume of work that needs to be performed at each workflow step. Workflows for the different workflow tasks may be engineered individually.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system configured to support user accounts in creating, managing and participating in online communities in accordance with some aspects of the present technology.

FIG. 2A illustrates an example of a user interface presented by a client application in accordance with some aspects of the present technology.

FIG. 2B illustrates an example of a user interface presented by a client application in accordance with some aspects of the present technology.

FIG. 3 illustrates an example diagram depicting an example system architecture of an asynchronous task service in accordance with some aspects of the present technology.

FIG. 4 illustrates an example diagram depicting a workflow generated from a workflow management system in accordance with some aspects of the present technology.

FIG. 5 illustrates an example flowchart diagram for generating a workflow using a workflow management system in accordance with some aspects of the present technology.

FIG. 6 illustrates an example diagram depicting an example system architecture of an asynchronous task service in accordance with some aspects of the present technology.

FIG. 7 illustrates an example of a computing system for implementing some aspects of the present technology.

### DETAILED DESCRIPTION

Various embodiments of the disclosure are discussed in detail below. While specific implementations are discussed, it should be understood that this is for illustration purposes only. A person skilled in the relevant art will recognize that other components and configurations may be used without parting from the spirit and scope of the disclosure.

Additional features and advantages of the disclosure will be set forth in the description which follows, and in part, will be obvious from the description or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by practicing the principles set forth herein.

Workflow management systems can generally provide an infrastructure for setting up and monitoring a customized set of workflow tasks that are arranged as a workflow. Generally, past workflow management systems are either focused on a defined sequence of workflow tasks or separately, scheduling concurrent workflow tasks to be run in parallel. However, more complex workflows may require an interplay of both sequential workflow tasks as well as concurrent workflow tasks. Specifically, a set of concurrent workflow tasks may depend on another set of concurrent workflow tasks. The first set of concurrent workflow tasks may be considered a first sequential workflow step, while the dependent set of concurrent workflow tasks may be considered as a second sequential workflow step that starts at the completion of the first sequential workflow step. For example, a workflow may require that a dataset of objects associated with payment history be aggregated and updated, and that may require that the objects be pulled from respective databases and then updated respectively.

In addition, some workflows may run only sequential workflow tasks, others may run only concurrent workflow tasks, and some may require an interplay of both as previously mentioned. As such, the disclosed technology addresses the need to have a workflow management system that provides different arrangements of workflows, specifically allowing for customization in both sequential workflow tasks and concurrent workflow tasks.

As such, the workflow management system customizes workflows of sequential workflow tasks with various dependencies. The workflow may have an input of a particular dataset of objects that needs to be operated on or analyzed to result in an intended output. The customization can include a number and order of sequential workflow steps as well as a number and function of workflow tasks to be executed in parallel at each of the workflow steps. In some cases, the workflow management system integrates three entities: a first entity that is associated with a top-level entity (workflow), a second entity that is associated with sequential workflow steps of the workflow (workflow steps), and a third entity associated with the workflow tasks that are run in parallel within each sequential workflow step (workflow tasks). The workflow tasks may encode what function should be called and what payload should be called with the function. When the workflow tasks are ready to be run, they may be queued up with an asynchronous task service that services a server that supports near real-time communications that require the workflow to operate successfully. The asynchronous task service may be a message-oriented middleware that provides a queue to parallelize workflow tasks.

Once the workflow is generated and saved at a database, the workflow may be initialized upon request. For a first sequential workflow step of the workflow, a particular dataset of objects may be set as the input. The dataset of objects may include segments of data or objects that need to be pulled, analyzed, or otherwise processed. In some cases, there may be a number of workflow tasks, all executing the same function, but with different arguments, or a number of workflow tasks, all executing different functions, or a combination of both.

For example, a workflow may require a first workflow step that retries any potentially failed payout calculations and a second workflow step of locking and submitting open payouts for a given month. The second workflow step here may depend on the first workflow step. Furthermore, to complete the first workflow step, a given dataset of objects associated with potentially failed payout calculations may be retried as a set of parallel workflow tasks. Once the given dataset of objects has been retried, then the second workflow step may commence, and open payouts may be locked and submitted respectively as another set of parallel workflow tasks.

A different workflow may include the reconciliation of transactions between databases and various payment gateways. In some cases, a single workflow step may include a single workflow task that runs a full day of transactions. Another workflow may include running a number of synchronizations sequentially, and each synchronization is associated with a different workflow task.

Tasks that run with parallel fan-out behavior may be integrated into a workflow. For example, a webhook may be received from a third-party service that indicates that there are issued fees. The webhook may initiate a number of workflow tasks (e.g., one for each charge, which may correspond to multiple fees) and write the fees into a database. The workflow may allow for one receipt of a webhook to be associated with a workflow step, which would need a number of workflow tasks run in parallel that would each be responsible for persisting a batch of fees corresponding to a single charge. The workflow management system may allow tracking of the process of which fees have been ingested and written into a billing database.

In some cases, the dataset of objects may be associated with a list of object identifiers, such as timestamps. A query may be run to determine the list of object identifiers and a division of the list of object identifiers may then be determined to result in a plurality of partitions of object identifiers. For example, the dataset of objects may be a set of data that needs to be pulled from a payment provider. The dataset of objects may be associated with a date range. The division of the date range may create a partition of smaller date ranges. Each smaller date range may be used to create a parameter for a partition of the dataset of objects for each workflow task. The workflow task may be a function that is defined at the generation of the workflow, and the first sequential workflow step may include one or more workflow tasks.

In some cases, the workflow tasks may push task messages to an asynchronous task service for each respective partition of dataset of objects, such that the asynchronous task service would receive as many task messages as there are workflow tasks. The workflow management system may then receive a first report that the workflow tasks of a first sequential workflow step have been completed and consequently initialize a second sequential workflow step of the workflow. The second sequential workflow step may have one or more workflow steps and the workflow management system may then receive a second report that the workflow tasks have been completed. If the workflow has only two workflow steps, then the workflow management system may determine that the workflow is completed.

In some cases, the workflow management system may provide an interface that visualizes the workflow and track a real-time progress of the workflow, including an auditing of any errors or failures and which workflow tasks they are related to. Furthermore, through the interface, an administrator can debug and retry particular workflow tasks without re-running the entire workflow.

In addition, for a server that supports near real-time communications, there may be different priority levels of workflow tasks. Some workflow tasks may be low priority workflow tasks that, as long as they are performed, timing is not important. For example, sending a confirmation email that a membership fee has been cancelled may be done within a couple of days. Other workflow tasks may need to be executed as soon as possible but if they do not successfully complete after a certain period of time, then they do not need to be performed. For example, embedding rendered information for a link when the link is typed in a message should be executed as soon as possible. Therefore, these different types of workflow tasks with different priority and workflows may need to be treated differently.

The server that supports near real-time communications may perform various asynchronous workflow tasks with the support of a customizable asynchronous task service by using custom libraries associated with workflows for different priority levels and types of workflow tasks. More specifically, the customizable asynchronous task service may create systems of event producers and consumers, called publishers and subscriber workers. Publishers communicate with subscriber workers asynchronously by a publisher-subscriber worker relationship where subscriber workers are explicitly subscribing to particular topics and only those subscriber workers are given the messages that go into the topic.

Publishers send messages pertaining to events to the asynchronous task service, without regard to the details of how or when these messages are to be processed. The asynchronous task service then delivers messages to all the subscriber workers or topics that react to them. A topic may be a type of queue that can receive messages that belong to the topic. A subscriber worker may be a logical entity or collection of logical entities that subscribe to messages associated with a topic, and that perform at least a portion of a workflow task associated with the message.

As such, the workflow may control the order, quantity, and function of the different workflow tasks of the workflow and push task messages to the customizable asynchronous task service for each partition of dataset of objects associated with a respective workflow task. In addition, any workflow task failures are reported at an interface that may also provide visibility into a real-time process in running the workflow or other workflows.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as data collection and/or use changes.

Although the present disclosure broadly covers the use of personal information data to implement one or more various disclosed embodiments, the present disclosure also contemplates that the various embodiments can also be implemented without the need for accessing such personal information data. The various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

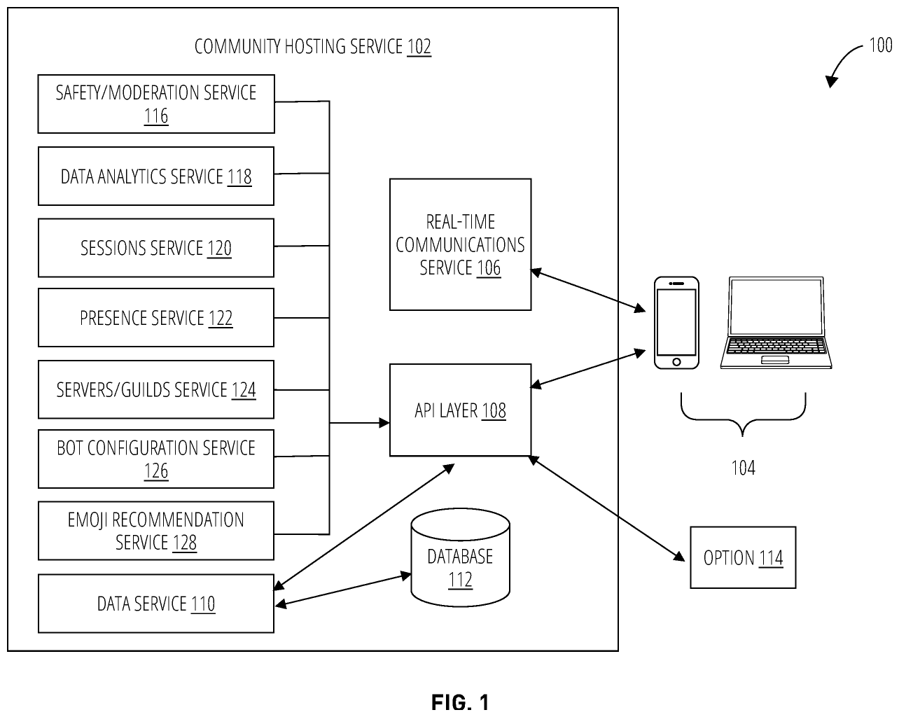

FIG. 1 illustrates an example system 100 configured to support user accounts in creating, managing, and participating in online communities. In particular, the system 100 supports a plurality of user accounts interacting with each other in communities to which they belong.

The system 100 illustrates an example architecture in which users of user accounts interact through an instance of client application 104 operating on a computing device. The client application 104 can be provided by a webpage rendered in a web browser or a downloaded client application executed by an operating system of the computing device. In some embodiments, some disparate collections of features or functionality might be available in client application 104 depending on the capabilities of the environment executing or rendering the client application 104.

The system 100 also includes a community hosting service 102, which provides an infrastructure for supporting the plurality of user accounts interacting with each other in communities to which they belong. The community hosting service 102 can be a distributed service hosted in a cloud computing architecture. The community hosting service 102 is responsible for hosting various services accessible to the user accounts by the client application 104.

In some embodiments, the community hosting service 102 provides a servers/guilds service 124 to enable user accounts to set up a server (also referred to as a guild) to host members interacting around one or more channels. A server (or guild) is a user-created environment supporting a community. A server is generally configured with one or more channels which are generally created around topics or sub-topics, or groups of people, and can support exchanges of communications between user accounts. Some channels are non-real-time channels where users communicate through written messages, images, emojis, recorded voice or video files, attachments, etc. Some channels are real-time communications channels that support voice or video communications. Some channels may be able to support both non-real-time messaging and real-time communications.

A user account can operate their instance of the client application 104 to create a server at the community hosting service 102. In some embodiments, this will be performed by the client application 104 calling the application programming interface (API) layer 110 requesting to create a new server. The API layer 110 can then interact with servers/guilds service 124 to create the server by providing the server with a unique identifier and associating various configurations requested by the user account. Once the server is created, the user account that created the server can be considered the owner and/or admin for the server. The servers/guilds service 124 can record the information about the server using data service 112 to store information about the server in database 114.

In some embodiments, servers can be configured to be public or private. A public server is one that any user can search for and request to join. A private server is one that a user needs to be invited to join. Depending on the configuration of the private server, a user can be invited by another user or may need to be invited by the administrator of the private server. Users can request to join a public or private server, and an entity with administrative privileges can grant the request.

In some embodiments, servers can be managed by the user account that created the server. Additionally, server administrators can delegate privileges to other user accounts to be administrators, and administrators can also create or invite bot 106, such as a chatbot, to perform some administrative actions.

In addition to approving user accounts to join a server, administrators can also set up various safety or content moderation policies. In some embodiments, those policies are enforced by user accounts with the administrator role for the server. In some embodiments, the policies can be enforced by software services provided by the community hosting service 102. such as the safety/moderation service 116 or bot 106.

As introduced above, servers are environments for supporting a community and are generally created around topics. In furtherance of that function, servers can be configured to integrate content through embedded channels or webhooks. For example, an administrator of a server might integrate a YOUTUBE channel, a TWITCH feed, or a TWITTER feed into one or more channels of the server when the content of those channels or feeds is relevant to the channels. In some embodiments, a server can follow a channel offered by another server supported by the community hosting service 102.

In addition to hosts, user accounts that are members of a server can also use their instance of client application 104 to interact with the community hosting service 102. The client application 104 can make requests to the community hosting service 102 to initiate a session with the community hosting service 102 and to access servers and channels to which the user account is a member, receive notifications and send messages, and otherwise communicate in the channels in which they belong.

As illustrated in FIG. 1, community hosting service 102 provides a variety of services that can be called by client application 104 or other services of the community hosting service 102.

For example, the community hosting service 102 includes a servers/guilds service 124. The servers/guilds service 124, as described above, can be used to create and administer a server. Additionally, the servers/guilds service 124 can also support various functions to those user accounts that are members of a server. For example, when an instance of client application 104 establishes a session using sessions service 120, the sessions service 120 can interact with servers/guilds service 124 to provide information regarding the servers to which the user account belongs. The client application 104 can receive identifiers of all servers to which the user account operating the client device associated with client application 104 is a member. While the session is active, client application 104 can request updates regarding one or more of the servers to which the user account operating client application 104 belongs from servers/guilds service 124.

Community hosting service 102 also provides a safety/moderation service 116. As with any online community, community hosting service 102 occasionally needs to deal with user accounts issuing spam or inappropriate content. While administrators of servers can perform some moderation functions such as suspending user accounts on a particular server or banning user accounts or bots for inappropriate posts or for posting spam, community hosting service 102 can have various software services that attempt to moderate some posts. For example, safety/moderation service 116 can include algorithms designed to detect hate speech or other harmful or inappropriate content. Safety/moderation service 116 can also include algorithms configured to identify communications as spam or phishing. Safety/moderation service 116 can provide various functions to protect users from content posted in a channel and attacks on client application 104 or the computing device hosting client application 104.

Community hosting service 102 can also include a data analytics service 118. The data analytics service 118 can provide various services in support of community hosting service 102 and in support of the users of community hosting service 102. For example, data analytics service 118 can monitor the performance of various features of the community hosting service 102 to determine whether updates to features are well received by the user community. The data analytics service 118 can also be used to develop and run various machine learning algorithms and other algorithms designed to identify harmful content, malicious servers, malicious user accounts, and malicious bot.

As introduced above, sessions service 120 is configured to authenticate a user account to community hosting service 102. After a user account has been authenticated, the sessions service 120 can determine one or more servers to which the user account is a member or for which the user account is an administrator. The sessions service 120 can send a list of identifiers for the servers associated with the user account to the client application 104. Thereafter, the client application 104 can request information regarding the servers by using a session token that validates that the client application 104 is operating in an authenticated session.

A presence service 122 can be used to provide presence information regarding other members of a server or a channel to which the user account belongs. Through the presence service 122, the client application 104 can convey information about which user accounts are currently active in the server or channel. Likewise, the client application 104 can provide presence information for the user account controlling the instance of client application 104.

Community hosting service 102 can also include a real-time communications service 108. The real-time communications service 108 is configured to support real-time communications such as live voice communications or video conferencing. In some embodiments, the real-time communications service 108 can be a public Internet service located outside a gateway for community hosting service 102. Real-time communications service 108 can provide real-time communications for channels configured to support real-time communications.

FIG. 1 also illustrates a bot configuration service 126 for creating and/or configuring one or more bot 106. The bot configuration service 126 can provide tools and template configurations to configure bots to take on a variety of roles within a channel of a server. The bot 106 can be created and configured by users of the community hosting service 102 and linked to servers chosen by the administrator. In some embodiments, the bot 106 can be configured as a chatbot that can have some understanding of the human language through natural language processing technologies. The bot 106 can be configured to provide some content moderation functions and/or some administrative functions. For example, the bot 106 might be granted permission to invite new members, send messages in a channel, embed links, remove members, delete messages, mute members, and attach files, among other possible functions. In some embodiments, bot 106 can have their own user account and are authenticated using a token. Bot 106 can have full access to all services of community hosting service 102.

FIG. 1 also illustrates an emoji recommendation service 128 for generating a ranking of emojis for a particular user in a particular server. The emoji recommendation service 128 can provide top ranked emojis to users when they are drafting messages at the server to be added to their messages. The ranking of the emojis may be determined based on a similarity score between a global emoji embedding space of an online community (i.e., one of the servers) with a user embedding space generated from the global emoji embedding space and generating a ranking of top emojis based on the measured similarity score in accordance with some aspects of the present technology. Furthermore, the global emoji embeddings may be created in an embedding space. The global emoji embeddings may comprise vectors representing past emoji usage by users in an online community over a period of time. In some cases, the emoji recommendation service 128 may be a part of or interfaces with the servers/guilds service 124.

While the community hosting service 102 is shown with just one of each service and database, it will be appreciated by those of ordinary skill in the art that community hosting service 102 can include many instances of each service or database, and in some embodiments, there can be different versions of the service or database that may utilize different technologies such as coding languages, database schemes, etc.

In some embodiments, the community hosting service 102 is configured such that the majority of communications between the community hosting service 102 and the client application 104 pass through API layer 110. The client application 104 can request responses from various services provided by the community hosting service 102 from the API layer 110. Additionally, services within the community hosting service 102 can communicate with each other by sending messages through the API layer 110. The client application 104 can also interact with a real-time communications service 108 for voice and video communication services. Although the community hosting service 102 is being described with respect to a particular system architecture and communication flow, it will be appreciated by those of ordinary skill in the art that other system configurations are possible.

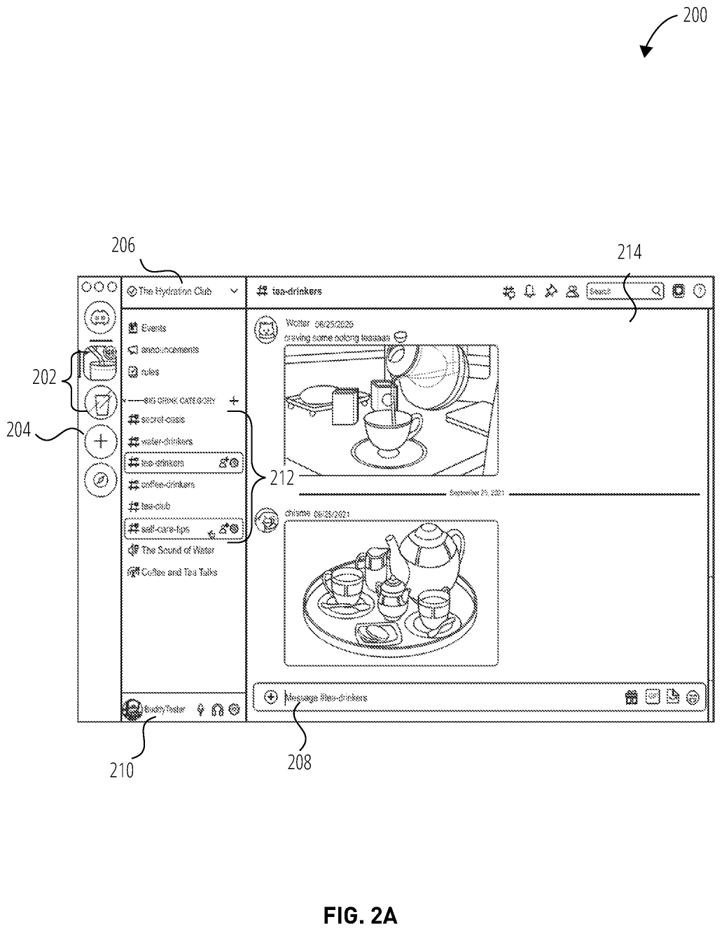

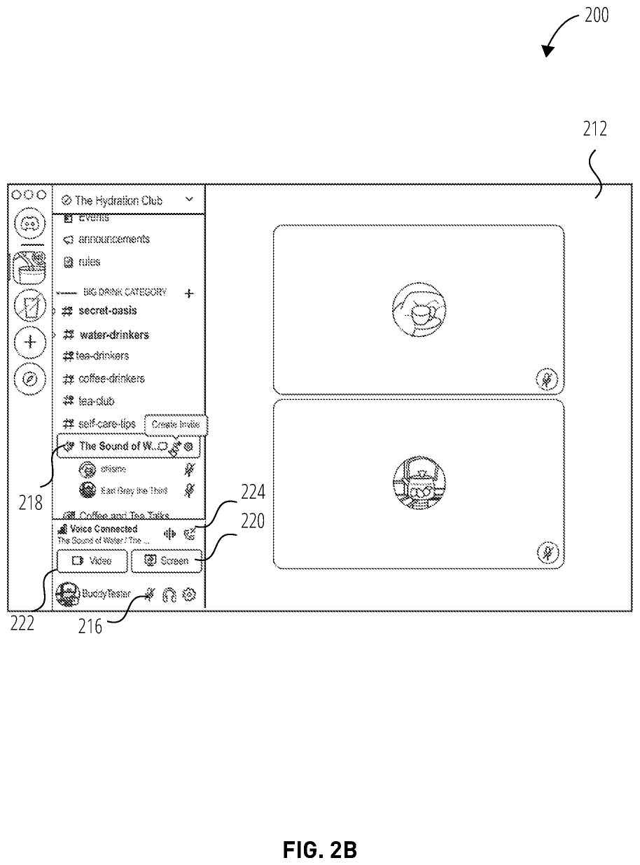

FIG. 2A illustrates an example of user interface 200 presented by client application 104.

User interface 200 includes icons for servers 202. The top icon has been selected and represents the “hydration club” server. The title 206 of the selected server, the “hydration club,” is presented at the top of the user interface 200. Options 212 include different messaging channels. For example, one channel, entitled “tea drinkers”, may be a non-real-time messaging channel. The message thread within the “tea drinkers” channel can be shown within a panel 214. As illustrated in FIG. 2A, the panel 214 may be configured to present content such as text messages, images, emojis, recorded voice or video files, attachments, etc. A user can provide content to be included in the channel using input interface 208. The server 202 includes another channel entitled “sound of water” as further described in FIG. 2B.

User interface 200 also includes a selectable option 204 to add additional servers. User interface 200 also includes a user account icon 210 and associated controls.

FIG. 2B illustrates another example of user interface 200 presented by client application 104. In FIG. 2B, option 218 entitled “sound of water” has been selected. The “sound of water” channel is a real-time communications channel. Accordingly, option 218 shows two user accounts engaged in real-time communications. As illustrated in FIG. 2B, the user account icon 210 and associated controls show that the user account's microphone 216 is muted. Additionally, the user account has option 220 or option 222 to share their video or screen, respectively. The user account can also disconnect from the real-time communications using option 224.

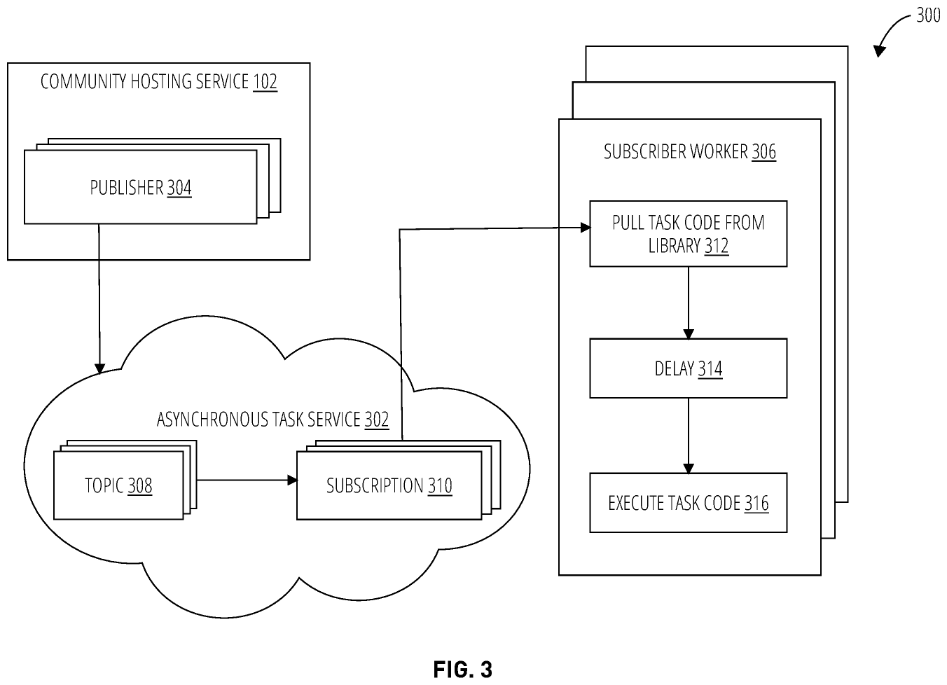

FIG. 3 illustrates an example diagram depicting an example system architecture of an asynchronous task service in accordance with some aspects of the present technology.

The community hosting service 102, and/or an API for the community hosting service 102, may include publishers 304 that send messages about workflow tasks to the asynchronous task service 301. The asynchronous task service 302 may be a cloud-based message-oriented middleware that sends messages associated with the workflow tasks back to the community hosting service 102. Publishers 304, such as publisher A, B, . . . N, may be a subclass of a single publisher. As a middleware layer, the asynchronous task service 302 allows software components (applications, servlets, and other components) that have been developed independently and that run on different networked platforms to interact with one another.

The message about a workflow task may describe a function to be performed (and other custom mechanisms) and the message about the workflow task may be sent to a specific topic, associated with a specific workflow task execution schedule, at the asynchronous task service 302 without a need for a formal schema or formal broker. The message may be sent to a specific topic based on a tag indicating that specific topic. The messages about workflow tasks sent to the asynchronous task service 302 may pertain to workflow tasks that only need to be executed within a reasonable amount of time (i.e., within a couple of days), workflow tasks that need to be executed as soon as possible but do not make sense after a certain amount of time, and workflow tasks that need to execute with as much effort as is reasonable to happen exactly once. For example, a stock-keeping unit (SKU) may be canceled and an email notifying that the SKU is canceled may be executed within a reasonable amount of time (i.e., within a couple of days). Embeds for uniform resource locators (URLs) in a message to be sent to the community hosting service 102 for including an attached image may be an example of workflow tasks that need to be executed as soon as possible but does not make sense after a certain amount of time. And renewal email reminders are an example of workflow tasks that need to execute with as much effort as is reasonable to happen exactly once.

The publishers 304 may send a message about a workflow task to a topic 308 of the asynchronous task service 302. The topic 308 can be a message queue appropriate for a specific workflow task execution schedule and/or a type of workflow task to which the message about the workflow task pertains. In some cases, the topics may include a default topic and a low priority topic as defaults. There may be more specific topics such as a topic specifically for embeds, which are time sensitive, and therefore it is important that they do not contend with other workflow tasks. There may be new custom topics that are built for the community hosting service 102 for specific performance guarantees and different retry policies. In some cases, the topics may specify that an exactly-once mechanism is turned on, whereby the workflow task is executed with as much effort as is reasonable to happen exactly once. For example, the exactly-once quality of service parameter may be encoded in the in-code config associated with a function such that the publisher will send the message to the appropriate topic, or the exactly-once quality of service parameter can be associated with the instructions tied to the topic to which the message is enqueued.

Once the respective topic 308, determined based on the selected topic associated with the message, receives the workflow task, the respective topic 308 enqueues the message associated with the workflow task. When the respective topic 308 causes a respective subscription 310 to perform an associated action, the respective subscriber worker 306 will either perform a pull request from or receive a push. In some cases, such as for scheduling workflow tasks and reoccurring workflow tasks, a pull request may be utilized. The subscriber worker 306 may then pull (312) messages with executable workflow task code from a respective library to execute the respective workflow task associated with the coded function in the message. In some cases, a delay 314 may be coded in the workflow task code that sets a delay mechanism that is custom to the workflow task and workflow task code. The workflow task code may include workflows that handle a number of subtasks that all depend on an initial subtask associated with the workflow task to be first initiated.

For example, workflow tasks with respect to reminders for renewal of membership fees need to be handled close to when the membership fee cycle is going to lapse. In some cases, a recurring workflow task that runs every hour or so may pull the membership fee renewals that are about to lapse in the next X days. Then, for each of those membership fee renewals, a workflow task may be scheduled to handle sending a reminder email to the membership fee owner. Essentially, there may be one logical workflow for dealing with each of the various workflow tasks, such as one workflow dealing with a logical membership fee lifecycle.

Tasks that are run manually in sequence may also be turned into a workflow. For example, month-end close processes may rely on a workflow task that retries the transaction within the month and groups payout-eligible transactions and prepares them for payout. Then, another workflow task that follows may lock and submit the payouts to a third-party provider. In some cases, the workflow task may be broken up even further into more workflow tasks that run multiple distinct time windows in parallel.

In some cases, a dashboard may be provided and can receive a message associated with a workflow task to generate a graph or analytics associated with the performance of the workflow task. The analytics may include how long the workflow task took, how long the workflow task took to send to the asynchronous task service 302, how long it took for the asynchronous task service 302 to send back to the community hosting service 102, a number of failures and success, and how many messages are still in the queue.

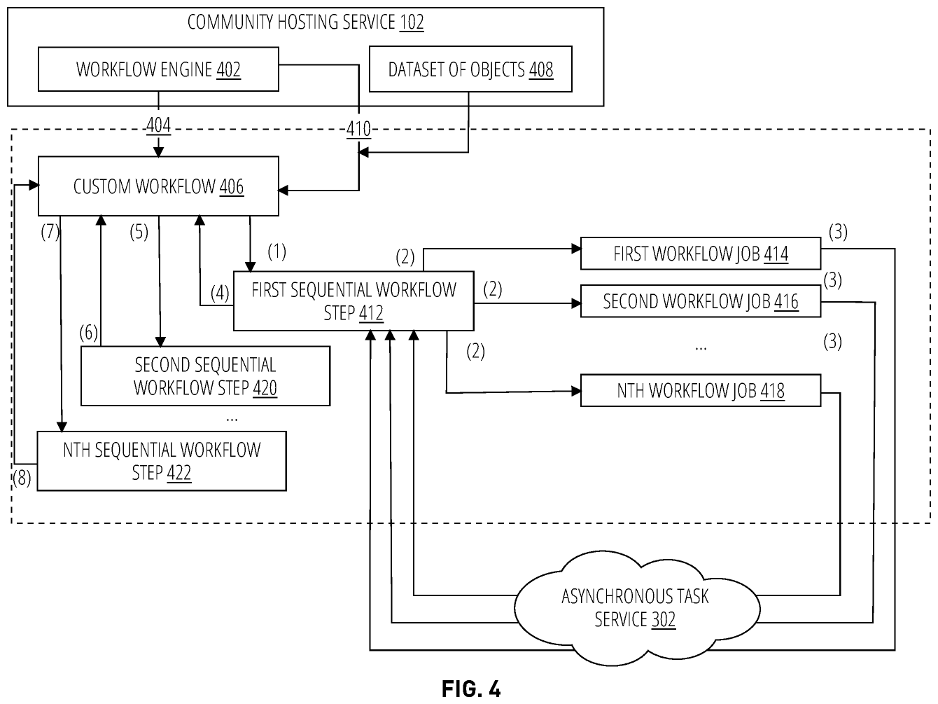

FIG. 4 illustrates an example diagram depicting a workflow generated from a workflow management system in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

As mentioned above, a workflow management system 402 may be used to create workflows that orchestrate workflow steps, which may be made up of one or more workflow tasks. In some cases, the workflow steps include dependencies that may send workflow tasks to the asynchronous task service 302 to run as parallel workflow tasks. The workflow tasks may be pushed as task messages to the asynchronous task service 302 that places the task messages in a queue and dequeued when the task message is pushed to a subscription. The task message may then be received at a subscriber worker to perform an associated workflow task. Therefore, the workflow management system assists with generating workflow that avoid having to run independent scripts in sequence with each independent script involving different dependencies. Furthermore, the workflow process may be monitored such that failures associated with particular workflow tasks may be called out and re-run without having to run the entire workflow.

The workflow management system 402 may start with generating (404) a workflow 406. The generation of the workflow 406 may be based on received inputs, at an interface, that indicate the order of the sequential workflow steps and the dependent workflow tasks of the workflow along with a respective function and payload that are called for each respective workflow task. In some cases, the functions are decorated as a workflow task by a designated API. In other words, when the function calls the API, a decorator may be applied to the function and may change parameters or values of the function to result in a particular workflow task. The workflow 406 may be saved to be used for different datasets of objects.

For a particular dataset of objects 408, the workflow management system 402 may initialize (410) the workflow 406, which may start by initializing a first sequential workflow step 412. The first sequential workflow step 412 may execute a number of different batches of a same workflow task, different workflow tasks, or a combination of the two. The different batches may be associated with different workflow tasks, such as a first workflow task 414, a second workflow task 416, and to an nth workflow task 418. The first workflow task 414, the second workflow task 416, and the nth workflow task 418 may be executed in parallel.

In some cases, running the first workflow task 414, the second workflow task 416, and the nth workflow task 418 may include pushing respective task messages to the asynchronous task service 302 that provides queues that parallelizes workflow tasks. Once the first workflow task 414, the second workflow task 416, and the nth workflow task 418 are complete, in accordance with the workflow, a second sequential workflow step 420 may be initialized. For example, there may be ten workflow tasks, all executing the same function, but with different arguments (which could be different partitions of a list of IDs, for example), or ten workflow tasks, all executing different functions, or a combination of both.

The second sequential workflow step 420 may also include workflow tasks that push workflow tasks messages to the asynchronous task service 302. The second sequential workflow step 420 may then be executed according to the workflow until it is complete. Each sequential workflow step may include one or more workflow tasks. Consequently, the workflow 406 would continue until the nth sequential workflow step 422 is completed. Each of the sequential workflow steps may include workflow tasks that push task messages to the asynchronous task service 302.

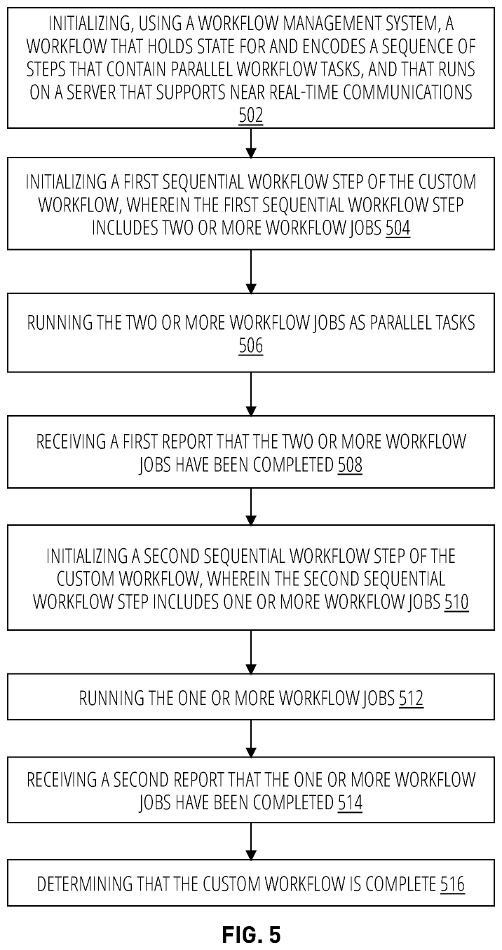

FIG. 5 illustrates an example flowchart diagram for generating a workflow using a workflow management system in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes initializing a workflow 406 for a dataset of objects 408 at block 502. For example, the workflow management system 402 and/or the community hosting service 102, illustrated in FIGS. 1 and 4, may initialize the workflow 406. The dataset of objects 408 may be identified by an input that is set with the workflow management system 402. The dataset of objects 408 may be a set of data that needs to be pulled, manipulated, or otherwise used to perform some function. The workflow 406 may hold state for and encodes a sequence of steps that contain parallel workflow tasks, and that runs on a server that supports near real-time communications

In some cases, the workflow management system integrates three entities: a first entity that is associated with a top-level entity (workflow), a second entity that is associated with sequential workflow steps of the workflow (workflow steps), and a third entity associated with workflow tasks that are run in parallel within each sequential workflow step (workflow tasks). The workflow tasks may encode what function should be called and what payload should be called with the function. When the workflow tasks are ready to be run, they may be queued up with an asynchronous task message server that services a server that supports near real-time communications. The asynchronous task service may be a message-oriented middleware that provides a queue to parallelize workflow tasks.

Furthermore, the workflow 406 may first be generated based on received inputs including an order and number of workflow steps and workflow tasks as well as respective functions associated with each workflow step. The workflow task may encode what function should be called and what payload should be called with the function. In some cases, the function may include data fetching, data manipulation, or other kinds of data processing.

According to some examples, the method includes initializing a first sequential workflow step 412 of the workflow 406, wherein the first sequential workflow step 412 includes two or more workflow tasks at block 504. According to some examples, the method includes running the two or more workflow tasks as parallel workflow tasks at block 506. For example, workflow management system 402 and/or the community hosting service 102. illustrated in FIGS. 1 and 4, may initialize the first sequential workflow step 412 and run the two or more workflow tasks.

In some cases, before initializing the first sequential workflow step 412 or as part of the first sequential workflow step 412, the workflow management system 402 may run a query to determine a list of object identifiers associated with the dataset of objects 408 and determine a division of the list of object identifiers to result in a plurality of partitions of object identifiers. For example, the dataset of objects may be a set of data or objects that needs to be processed in a particular fashion and may be associated with a plurality of object identifiers. The division of the object identifiers may create partitions of object identifiers of the dataset of objects 408.

For example, the dataset of objects 408 may include 10,000 rows of data, with each row associated with a particular object identifier, such as the row number. The workflow management system 402 may determine that a best partition of the dataset of objects 408 is to split the 10,000 rows into ten 1,000 rows. As such, each 1,000 rows may be considered a partition of the dataset of objects and associated with a workflow task of the first sequential workflow steps 412. Therefore, for this example dataset of objects 408, there would be ten workflow tasks, each responsible for 1,000 rows. The workflow task may be a function that is defined at the generation of the workflow.

In some cases, a machine-learning model may receive the list of object identifiers as an input and may output the plurality of partitions of object identifiers. The machine-learning model may be trained based on sets of partitions and associated time periods to complete respective workflow tasks. The machine-learning model may be trained to output a most efficient set of partitions.

In running the parallel workflow tasks, the workflow management system 402 may push the two or more workflow tasks as respective task messages to an asynchronous task service 302 that provides queues that parallelize workflow tasks. More specifically, a first task message may be associated with a first workflow task of the two or more workflow tasks and may be pushed from a publisher 304 of the community hosting services 102, or server that supports near real-time communications, to a topic 308 of the asynchronous task service 302. The topic 308 may include a message queue and place the first task message in the message queue. The first task message may then be pushed to a subscription 310 when the first task message is dequeued. The first task message may then be received at the subscriber worker 306.

Similarly, a second task message associated with a second workflow task of the two or more workflow tasks may also be pushed from the publisher 304 to the topic 308. The second task message may be received at the subscriber worker 306 at a different time as when the first task message was received. In some cases, a delay mechanism is set before executing the function described in the first task message. Furthermore, running each workflow tasks may be idempotent.

According to some examples, the method includes receiving a first report that the two or more workflow tasks have been completed at block 508. For example, workflow management system 402 and/or the community hosting service 102, illustrated in FIGS. 1 and 4, may receive the first report. The first report may indicate to the workflow management system 402 that the workflow 406 may proceed.

According to some examples, the method includes initializing a second sequential workflow step of the workflow at block 510. For example, workflow management system 402 and/or the community hosting service 102, illustrated in FIGS. 1 and 4, may initialize the second sequential workflow step 420. In some cases, the second sequential workflow step 420 may include one or more workflow tasks. According to some examples, the method includes running the one or more workflow tasks at block 512.

According to some examples, the method includes receiving a second report that the one or more workflow tasks have been completed at block 514. If the workflow 406 only includes the two workflow steps, according to some examples, the method includes determining that the workflow is complete at block 516. If the workflow 406 includes more workflow steps. each step may be initialized in response to a conclusion of a previous step until the workflow is complete.

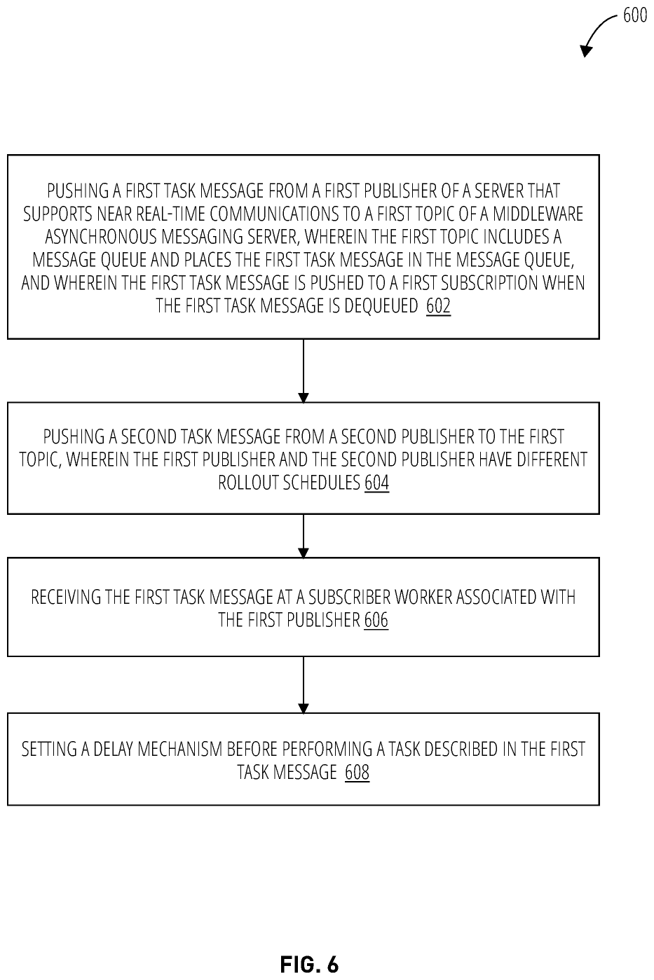

FIG. 6 illustrates an example diagram depicting an example system architecture of an asynchronous task service in accordance with some aspects of the present technology. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some examples, the method 600 includes pushing a first task message from a first publisher of a server that supports near real-time communications to a first topic of an asynchronous task service at block 602. For example, the community hosting service 102 and/or the API layer 110, illustrated in FIGS. 1 and 4, may push the first task message from the first publisher to the first topic of the asynchronous task service or asynchronous task service 302. In some cases, the first topic pushes the first task message to a first subscription. The first topic may be a default topic, a low priority topic, or a customized topic, such as an embed topic. In some cases, first topic includes a message queue and places the first task message in the message queue, and the first task message is pushed to a first subscription when the first task message is dequeued. The topics use queue-like semantics. The message queue is not guaranteed by default but can be added as a requirement. The workflow tasks may publish messages to a same topic for specifically executing workflow tasks.

According to some examples, the method 600 includes pushing a second task message from a second publisher to the first topic at block 604. The first publisher and the second publisher may have different workflow task execution schedules with respect to when the workflow tasks are performed at the community hosting service 102. For example, the community hosting service 102 and/or the API layer 110, illustrated in FIGS. 1 and 4, may push the second task message from the second publisher to the first topic. The different workflow task execution schedules may be set as a delay mechanism that is appended to the task message.

According to some examples, the method 600 includes receiving the first task message at a subscriber worker associated with the first publisher, at block 604. For example, the community hosting service 102 and/or the API layer 110, illustrated in FIGS. 1 and 4, may receive the first task message at the subscriber worker associated with the first publisher. In some cases, for each topic there is a corresponding subscription and along with a corresponding subscriber worker that handles the workflow tasks for that subscription. When the corresponding subscriber worker is ready to handle the workflow task, the corresponding subscriber worker may receive a respective API call associated with the workflow task.

For example, in a streaming pull subscription model, the subscriber workers may ask for up to k messages at a time and at most k messages will be given at a time to that subscriber worker. A subscriber worker 306, such as subscriber worker A, B, . . . N, can indicate to the asynchronous task service 302 that it is ready for up to k messages (k is configurable in our aforementioned in-code configs per-topic/subscription pair). The asynchronous task service 302 may give the respective subscriber worker 306 at most k messages. The subscriber worker 306 may then unwraps each message and locate the workflow task's function name, arguments, and keyword arguments. The subscriber worker 306 may then run that function (i.e., runs the workflow task) with those arguments and keyword arguments. If successful, the subscriber worker 306 acknowledges (sending ACKs) the message to the asynchronous task service 302. If there's an error, the subscriber worker 306 does not acknowledge (NACK the message), which the asynchronous task service 302 receives as an intent to retry the message after some backoff period of time.

According to some examples, the method 600 includes setting the delay mechanism before performing a workflow task described in the first task message at block 608. For example, the community hosting service 102 and/or the API layer 110, illustrated in FIGS. 1 and 4, may set the delay mechanism before performing the workflow task described in the first task message. In some cases, the delay message may be a few minutes. The delay mechanism may be sent when a workflow task is published. In some cases, the delay mechanism can vary even with a type of workflow task. For example, a workflow task foobar may be scheduled once with delay_ms=6000 and then again later with delay_ms=1000000.

In some cases, when the subscriber worker 306 receives the workflow task, the subscriber worker 306 reads the message payload at the delay_ms parameter. If the time between workflow task publish time and now is less than X seconds, such as 4 seconds, sleep() is executed in the subscriber process for the amount of time needed to respect the requested delay. If it's more than the X seconds, the message does not get acknowledged (NACK the message), which sends the message back to the asynchronous task service 302. The exponential backoff of the asynchronous task service 302 retries to try the workflow task again later. This means that delay is a lower bound, not an upper bound i.e., there is a guarantee of a delay of at least X milliseconds, but no guarantees as to the maximum amount of delay.

In some cases, the method 600 may include pushing a third task message from a third publisher of the server that supports near real-time communications to a second topic of the asynchronous task service 302. The second topic may push the third task message to a second subscription, and the second topic may be associated with latency sensitive workflow tasks. In some cases, the third task message may be received at a second subscriber worker associated with the second publisher and the workflow task described in the third task message may be performed in response. For example, the workflow task may be embedding an image associated with a URL in a message. Furthermore, the workflow task may be canceled if the workflow task is not performed in a certain period of time.

In some cases, other types of topics may include billing workflow tasks that need exactly-once semantics or billing workflow tasks that do not need exactly-once semantics. For example, for billings workflow tasks that need exactly-once semantics, the asynchronous task service 302 is notified that a particular topic would enforce the exactly-once semantics. These types of workflow tasks may have their own topic. In some cases, for workflow tasks that are being transferred from another open-source asynchronous task service, analogous topics may be created such that one-to-one mapping between topics may keep the same topics and their respective settings intact.

According to some examples, the method 600 includes receiving a request to create a new topic at the asynchronous task service. In some cases, topics are created before workflow tasks are scheduled in production and are configured a priori. The new topic may be associated with a project with workflow tasks to be performed at the server that supports near real-time communications. The topic may include custom settings and retry policies for specific workflow tasks that may not be best served if contended with other workflow tasks with different priorities. For example, an exactly-once semantic may be selected for the new topic.

According to some examples, the method 600 includes receiving a request to generate a logical workflow associated with the workflow task, wherein the logical workflow includes subtasks that are triggered by the workflow task. In some cases, the subtasks may require sending a subtask back to the asynchronous task service 302.

According to some examples, the method 600 includes setting a guard associated with the first publisher, wherein the guard limits a percentage of times that workflow tasks sent from the first publisher are sent to the asynchronous task service. In some cases, the task message is not limited by the guard and in other cases, the task message is limited and is routed to another open-source asynchronous task service.

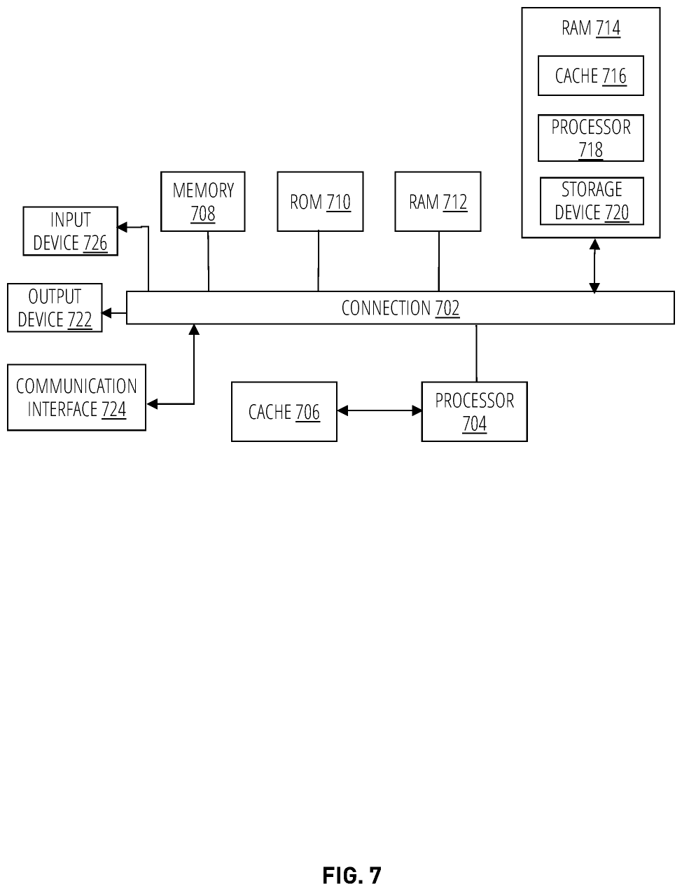

FIG. 7 shows an example of computing system 700, which can be any computing device making up client application 104, community hosting service 102, or any component thereof in which the components of the system are in communication with each other using connection 702. Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) 704 and connection 702 that couples various system components including system memory 708, such as read-only memory (ROM) 710 and random access memory (RAM) 712 to processor 704. Computing system 700 can include a cache of high-speed memory 706 connected directly with, in close proximity to, or integrated as part of processor 704.

Processor 704 can include any general purpose processor and a hardware service or software service, such as services 716, services 718, and services 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, RAMs, read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the necessary hardware components, such as processor 704, connection 702, output device 722, etc., to carry out the function.

For clarity of explanation, in some instances, the present technology may be presented as including individual functional blocks including functional blocks comprising devices, device components, workflow steps or routines in a method embodied in software, or combinations of hardware and software.

Any of the workflow steps, operations, functions, or processes described herein may be performed or implemented by a combination of hardware and software service or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method workflow steps, it is to be understood that the subject matter defined in the appended claims is not necessarily limited to these described features or acts. For example, such functionality can be distributed differently or performed in components other than those identified herein. Rather, the described features and workflow steps are disclosed as examples of components of systems and methods within the scope of the appended claims.

What is claimed is:

1. A computer-implemented method comprising:
initializing, using a workflow management system, a workflow that holds state for and encodes a sequence of steps that contain parallel workflow tasks, and that runs on a server that supports near real-time communications;
initializing a first sequential workflow step of the workflow, wherein the first sequential workflow step includes two or more workflow tasks, wherein each workflow tasks is associated with a function;
running the two or more workflow tasks as parallel workflow tasks;
receiving a first report that the two or more workflow tasks have been completed;
initializing a second sequential workflow step of the workflow, wherein the second sequential workflow step includes one or more workflow tasks;
running the one or more workflow tasks;
receiving a second report that the one or more workflow tasks have been completed; and
determining that the workflow is complete.

2. The computer-implemented method of claim 1, wherein the running of the two or more workflow tasks as parallel workflow tasks includes pushing the two or more workflow tasks as respective task messages to an asynchronous task service that provides queues that parallelize workflow tasks.

3. The computer-implemented method of claim 2, further comprising:
pushing a first task message associated with a first workflow task of the two or more workflow tasks from a publisher of the server that supports near real-time communications to a topic of the asynchronous task service, wherein the topic includes a message queue and places the first task message in the message queue, and wherein the first task message is pushed to a subscription when the first task message is dequeued;
pushing a second task message associated with a second workflow task of the two or more workflow tasks from the publisher to the topic;
receiving the first task message at a subscriber worker associated with the publisher, wherein the subscriber worker executes the respective function; and
receiving the second task message at the subscriber worker associated with the first publisher, wherein the subscriber worker executes the respective function.

4. The computer-implemented method of claim 1, further comprising:
running a query to determine a list of object identifiers associated with the dataset; and
determining a division of the list of object identifiers that results in a plurality of partitions of object identifiers, wherein each workflow task of the two or more workflow tasks is associated with a respective partition of object identifiers.

5. The computer-implemented method of claim 4, wherein the division is determined based on a machine-learning model that receives the list of object identifiers as an input and outputs the plurality of partitions of object identifiers, wherein the machine-learning model is trained based on sets of partitions and associated time periods to complete respective workflow tasks, and wherein the machine-learning model is trained to output a most efficient set of partitions.

6. The computer-implemented method of claim 1, further comprising:
before initializing the workflow, receiving an input to store the workflow including the first sequential workflow step and the second sequential workflow step; and
receiving an input for each workflow task to encode a function to be called and a payload to be called with.

7. The computer-implemented method of claim 6, further comprising:
providing an application programming interface (API) for decorating each function as a workflow task.

8. The computer-implemented method of claim 1, further comprising:
causing to display a dashboard for monitoring process of the workflow, including a status of each of the workflow steps and workflow tasks.

9. The computer-implemented method of claim 1, wherein each workflow task of the two or more workflow tasks are associated with a same function.

10. The computer-implemented method of claim 1 further comprising:
receiving an input to add a third sequential workflow step to the workflow; and
initializing the workflow for a second dataset of objects, wherein the workflow includes the first sequential workflow step, the second sequential workflow step, and the third sequential workflow step.

11. A system comprising:
a processor; and
a memory storing instructions that, when executed by the processor, configure the system to:
initialize, using a workflow management system, a workflow that holds state for and encodes a sequence of steps that contain parallel workflow tasks, and that runs on a server that supports near real-time communications;
initialize a first sequential workflow step of the workflow, wherein the first sequential workflow step includes two or more workflow tasks, wherein each workflow tasks is associated with a function;
run the two or more workflow tasks as parallel workflow tasks;
receive a first report that the two or more workflow tasks have been completed;
initialize a second sequential workflow step of the workflow, wherein the second sequential workflow step includes one or more workflow tasks;
run the one or more workflow tasks;
receive a second report that the one or more workflow tasks have been completed; and
determine that the workflow is complete.

12. The system of claim 11, wherein the running of the two or more workflow tasks as parallel workflow tasks includes pushing the two or more workflow tasks as respective task messages to an asynchronous task service that provides queues that parallelize workflow tasks.

13. The system of claim 12, wherein the instructions further configure the system to:
push a first task message associated with a first workflow task of the two or more workflow tasks from a publisher of the server that supports near real-time communications to a topic of the asynchronous task service, wherein the topic includes a message queue and places the first task message in the message queue, and wherein the first task message is pushed to a subscription when the first task message is dequeued;
push a second task message associated with a second workflow task of the two or more workflow tasks from the publisher to the topic;
receive the first task message at a subscriber worker associated with the publisher, wherein the subscriber worker executes the respective function; and
receive the second task message at the subscriber worker associated with the first publisher, wherein the subscriber worker executes the respective function.

14. The system of claim 11, wherein the instructions further configure the system to:
run a query to determine a list of object identifiers associated with the dataset; and
determine a division of the list of object identifiers that results in a plurality of partitions of object identifiers, wherein each workflow task of the two or more workflow tasks is associated with a respective partition of object identifiers.

15. The system of claim 14, wherein the division is determined based on a machine-learning model that receives the list of object identifiers as an input and outputs the plurality of partitions of object identifiers, wherein the machine-learning model is trained based on sets of partitions and associated time periods to complete respective workflow tasks, and wherein the machine-learning model is trained to output a most efficient set of partitions.

16. The system of claim 11, wherein the instructions further configure the system to:
before initializing the workflow, receiving an input to store the workflow including the first sequential workflow step and the second sequential workflow step; and
receiving an input for each workflow task to encode a function to be called and a payload to be called with.

17. The system of claim 16, wherein the instructions further configure the system to:
providing an application programming interface (API) for decorating each function as a workflow task.

18. The system of claim 11, wherein the instructions further configure the system to:
causing to display a dashboard for monitoring process of the workflow, including a status of each of the workflow steps and workflow tasks.

19. The system of claim 11, wherein each workflow task of the two or more workflow tasks is associated with a same function.

20. A non-transitory computer-readable storage medium, the computer-readable storage medium including instructions that when executed by a computer, cause the computer to:
initializing, using a workflow management system, a workflow that holds state for and encodes a sequence of steps that contain parallel workflow tasks, and that runs on a server that supports near real-time communications;
initializing a first sequential workflow step of the workflow, wherein the first sequential workflow step includes two or more workflow tasks, wherein each workflow tasks is associated with a function;
running the two or more workflow tasks as parallel workflow tasks;
receiving a first report that the two or more workflow tasks have been completed;
initializing a second sequential workflow step of the workflow, wherein the second sequential workflow step includes one or more workflow tasks;
running the one or more workflow tasks;
receiving a second report that the one or more workflow tasks have been completed; and
determining that the workflow is complete.
